(19) United States
(12) Patent Application Publication
(10) Pub. No.: US 2026/0100568 A1
(43) Pub. Date: Apr. 9, 2026

(54) CABLE SPLICE SLEEVE ASSEMBLIES AND METHODS FOR HOUSING AND PROTECTING CABLE SPLICES IN MEDIUM AND HIGH VOLTAGE APPLICATIONS

(71) Applicant: Sonic Connectors, Ltd., Midland, TX (US)

(72) Inventors: Bradley Yingst, Friendswood, TX (US); Brody Whitley, Midland, TX (US)

(21) Appl. No.: 19/353,463

(22) Filed: Oct. 8, 2025

Related U.S. Application Data
(60) Provisional application No. 63/705,229, filed on Oct. 9, 2024.

(51) Int. Cl. H02G 15/18

(52) U.S. Cl. CPC H02G 15/18

(57) ABSTRACT

The present disclosure relates to a cable splice sleeve assembly including a removable core spirally wrapped to form a hollow cylinder having an outer surface, an inner surface, and an end piece, the inner surface configured to receive spliced cables; and a pre-expanded, flexible elastomeric sleeve stretched to fit about the outside surface of the removable core, wherein the removable core is configured so that pulling the end piece unravels the removable core, thereby removing the removable core from an interior surface of the elastomeric sleeve so that the elastomeric sleeve contracts onto the spliced cables.

### CROSS-REFERENCE SECTION

This application is a U.S. Non-Provisional Application claiming priority to U.S. Non-Provisional Application No. 63/705,229, filed on October 9, 2024, which is incorporated by reference in its entirety.

### FIELD OF THE DISCLOSURE

This application relates to cable splice sleeves for an electrical power cable, in particular both medium voltage power cable and high-voltage power cable applications.

### BACKGROUND

Known shrink tubes for electrical power cables use heat-shrinkable polymeric materials to provide sleeves around electrical cables that have been electrically connected together (i.e., spliced together). Generally, high heat from a flame or heat gun required to “shrink” the shrink tubes into place. However, using high heat comes with the primary dangers of thermal burns from contact with the heated tube or heat gun, toxic fumes from overheating or burning the polymeric materials, and damage to electrical components from excessive or uneven heat. Further, with respect to the oil and gas industry, heating tools such as heat guns, torches having an open flame, etc. are not intrinsically safe for use at or near a wellhead because they can ignite gases coming from downhole. A system is needed that securely protects the spliced cables while not requiring excess heat, or even any heat, to do so.

The main reason is that heating tools such as heat guns, torches, open flames etc. are not intrinsically safe for use at or near a wellhead. The cold shrink allows a superior method of electrical isolation without the need for non-intrinsically safe equipment.

A new approach to addressing these issues is presented herein.

### SUMMARY

According to some embodiments, the present disclosure relates to a cable splice sleeve assembly including a removable core spirally wrapped to form a hollow cylinder having an outer surface, an inner surface, and an end piece, the inner surface configured to receive spliced cables. The cable splice sleeve assembly may include a pre-expanded, flexible elastomeric sleeve stretched to fit about the outside surface of the removable core. In some embodiments, the removable core may be configured so that pulling the end piece unravels the removable core, thereby removing the removable core from an interior surface of the elastomeric sleeve so that the elastomeric sleeve contracts onto the spliced cables.

In some embodiments, a cable splice sleeve assembly may be configured to provide insulation and protection for at least one of medium-voltage applications and high-voltage applications, including power distribution systems and oilfield operations, where the cold shrink method offers substantial safety and performance advantages. A removable core may include a polymer including a polyethylene, a polystyrene, a polyvinyl chloride, a nylon, a polypropylene, a polyethylene terephthalate, a polycarbonate, and copolymers thereof. The removable core may include a metal including an aluminum, an iron, a steel, a copper, a zinc, a bronze, an alloy steel, a gold, a silver, a tin, and alloys thereof. The removable core may have inside diameter ranging from about 0.1 inches to about 10 inches. The removable core may have outside diameter ranging from about 0.2 inches to about 11 inches. The removable core may have length ranging from about 0.5 inches to about 10 inches. The flexible elastomeric sleeve may include an elastomer including silicone rubber, natural rubber, styrene-butadiene, neoprene, chloroprene, polybutadiene, butyl rubber, ethylene propylene-diene monomer (EPDM) rubber, a nitrile, a polyurethane, a polyurethane, and co-polymers thereof. The cable splice sleeve assembly may be configured to provide insulation and protection for voltage applications ranging from about 1 kV to about 69 kV, or higher.

According to some embodiments, the present disclosure relates to a method for installing a cable splice sleeve assembly, the method including positioning the cable splice sleeve assembly so that an inner surface of a removable core of the cable splice assembly covers a junction at which electrical cables have been spliced together. The cable splice sleeve assembly may include the removable core spirally wrapped to form a hollow cylinder having an outer surface, the inner surface, and an end piece; and a pre-expanded, flexible elastomeric sleeve stretched to fit about the outside surface of the removable core. The method may include pulling the end piece to unravel the removable core, thereby removing the removable core from an interior surface of the elastomeric sleeve so that the elastomeric sleeve contracts onto the spliced cables

In some embodiments, the present disclosure relates to a cable splice assembly including a hollow cylindrical frame including a first open end connected to a second open end by an elongate body; an outer surface and an inner surface; and at least one set screw port in the hollow cylindrical frame. The hollow cylindrical frame has an inside diameter ranging from about 0.1 inches to about 10 inches. The hollow cylindrical frame has an outside diameter ranging from about 0.2 inches to about 11 inches. The hollow cylindrical frame has a length ranging from about 0.5 inches to about 10 inches.

In some embodiments, a cable splice assembly may be made from a non-conductive material including a polymer including a polyethylene, a polystyrene, a polyvinyl chloride, a nylon, a polypropylene, a polyethylene terephthalate, a polycarbonate, and copolymers thereof. The cable splice assembly may be made from a non-conductive material including a ceramic including porcelain, quartz, alumina, silica, boron nitride, aluminum nitride, silicon nitride, sialons, and combinations thereof. A non-conductive cable splice assembly may serve as a protective barrier for the cold shrink tube and provides further electrical isolation between cables or from a ground source. The non-conductive splice sleeve may have a mechanical retention feature, such as set screws or other clamping mechanisms, to prevent lateral movement along the assembly, ensuring the stability and protection of the cable splice. The cable splice assembly may be made from a conductive material including silver, copper, gold, aluminum, nickel, brass, steel, platinum, lead, carbon steel, and alloys thereof. The cable splice assembly has from 1 to 20 set screw ports through the hollow cylindrical frame. At least one set screw port through the hollow cylindrical frame may have a diameter ranging from about 0.1 inch to about 1 inch. An outside diameter of the hollow cylindrical frame at the first open end may be larger than the outside diameter of the hollow cylindrical frame at the second open end. The cable splice assembly may include a divider bisecting the hollow cylindrical frame, the divider having a thickness ranging from about 0.01 inch to about 1 inch.

Additional features and advantages of the present disclosure are described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram a cable splice sleeve, in accordance with some embodiments.

FIG. 2 is a schematic diagram of a cable splice assembly, in accordance with some embodiments.

FIG. 3A is a cross-sectional view of a cable splice assembly, in accordance with some embodiments.

FIG. 3B is a top view cross-sectional view of the cable splice assembly of FIG. 3A, in accordance with some embodiments.

FIG. 4 is a side perspective of a cable splice assembly, in accordance with some embodiments.

### DETAILED DESCRIPTION

The present disclosure relates to cable splice sleeve assemblies, methods of installing cable splice sleeve assemblies, and cable splice assemblies having screw ports. The cable splice sleeve assemblies disclosed herein can protect and insulate junctions in which electrical cables have been spliced together without requiring heat to shrink a pre-expanded flexible elastomeric sleeve about the junction. Similarly, disclosed cable splice assemblies, being made of either conductive or non-conductive materials, provide a protection of similar junctions without having to be shrunk over the splicing area, but instead have screw ports where screws can be used to secure ends of electrical cables.

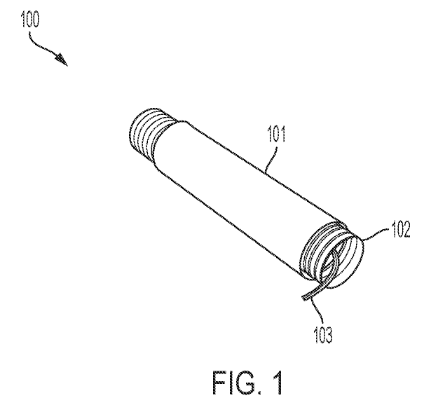

FIG. 1 illustrates a cable splice sleeve assembly 100, according to the disclosed embodiments. As shown in FIG. 1, the cable splice sleeve assembly 100 may include a removable core 102 spirally wrapped to form a hollow cylinder having an outer surface, an inner surface, and an end piece 103. The inner surface of the removable core 102 may be configured to receive spliced cables. The cable splice sleeve assembly 100 may include a pre-expanded, flexible elastomeric sleeve 101 stretched to fit about the outside surface of the removable core 102. In some embodiments, the removable core 102 is configured so that pulling the end piece 103 unravels the removable core 102, thereby removing the removable core 102 from an interior surface of the elastomeric sleeve 101 so that the elastomeric sleeve 101contracts onto the spliced cables.

In some embodiments, as shown in FIG. 1, a cable splice sleeve assembly 100 may be configured to provide insulation and protection for at least one of medium-voltage applications and high-voltage applications. For example, the cable splice sleeve assembly 100 may provide insulation and protection for voltage applications ranging from about 1 kV to about 35 Kv (i.e., medium voltage), or even above 35 kV (i.e., high voltage). Disclosed cable splice sleeve assemblies 100 may provide insulation and protection for voltage applications of even up to 69 kV, or higher.

As shown in FIG. 1, a cable splice sleeve (cold shrink tubing) assembly 100 may include a removable core 102. The removable core 102 may be made of a polymer comprising a polyethylene, a polystyrene, a polyvinyl chloride, a nylon, a polypropylene, a polyethylene terephthalate, a polycarbonate, and copolymers thereof. The removable core 102 may be made of a metal comprising an aluminum, an iron, a steel, a copper, a zinc, a bronze, an alloy steel, a gold, a silver, a tin, and alloys thereof.

A removable core 102 may have an inside diameter ranging from about 0.1 inches to about 10 inches. For example, the removable core 102 may have an inside diameter of about 0.1 inches, or about 1 inch, or about 2 inches, or about 4 inches, or about 6 inches, or about 8 inches, or about 10 inches, where about includes plus or minus 0.5 inches. The removable core 102 may have an outside diameter ranging from about 0.2 inches to about 11 inches. For example, the removable core 102 may have an outside diameter of about 0.2 inches, or about 1 inch, or about 2 inches, or about 4 inches, or about 6 inches, or about 8 inches, or about 10 inches, or about 11 inches, where about includes plus or minus 0.5 inches. The removable core 102 may have a length ranging from about 0.5 inches to about 10 inches. For example, the removable core 102 may have a length of about 0.5 inches, or about 1 inch, or about 2 inches, or about 4 inches, or about 6 inches, or about 8 inches, or about 10 inches, where about includes plus or minus 0.5 inches.

As shown in FIG. 1, the cable splice sleeve 100 may include a flexible elastomeric sleeve 101. The flexible elastomeric sleeve 101 may be made of various elastomeric materials, including silicone rubber, natural rubber, styrene-butadiene, neoprene, chloroprene, polybutadiene, butyl rubber, ethylene propylene-diene monomer (EPDM) rubber, a nitrile, a polyurethane, a polyurethane, and co-polymers thereof. For example, the flexible elastomeric sleeve 101 may be made of EPDM. In some embodiments, the cable splice sleeve 100, being made of disclosed polymers, may maintain elasticity and form a tight seal around the cable. This elasticity ensures that the sleeve can accommodate thermal expansion and contraction while continuing to provide an effective environmental seal against moisture, dust, and other contaminants.

In some embodiments, the present disclosure relates to methods for installing a disclosed cable splice sleeve assembly 100, as shown in FIG. 1. The disclosed method may include positioning the cable splice assembly 100 so that an inner surface of a removable core 102 of the cable splice assembly 100 covers a junction at which electrical cables have been spliced together. The method may include pulling an end piece 103 of the removable core 102, thereby removing the removable core 102 from an interior surface of the flexible elastomeric sleeve 101 so that the pre-expanded core contracts onto the spliced cables.

Besides having a cylindrical shape (i.e., circular cross-section), disclosed a cable splice sleeve assemblies 100 may have cross-sections including a square, a triangle, a circle, an oval, a polygon, a rectangle, a rhombus, and more.

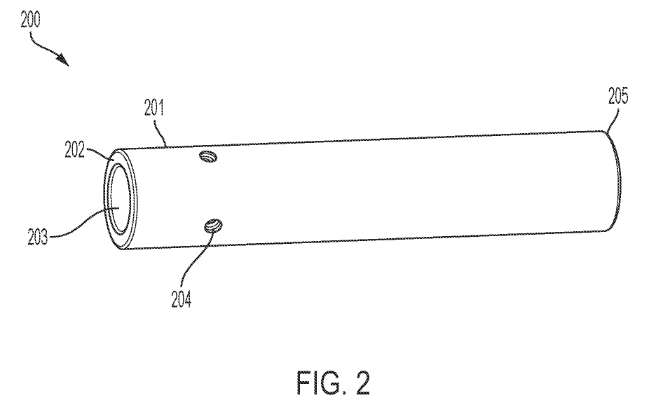

FIG. 2 is a schematic diagram of a cable splice assembly 200, in accordance with some embodiments. Unlike the cable splice sleeve assemblies (cold shrink tubes) 100, disclosed cable splice assemblies 200 provide a protection of similar junctions without having to be shrunk over the splicing area since they incorporate screw ports where screws can be used to secure ends of electrical cables. A disclosed cable splice assembly 200 may include a hollow cylindrical frame having a first open end 202 connected to a second open end 205 by an elongate body. The cable splice assembly 200 may include an outer surface 201 and an inner surface 203. The cable splice assembly 200 may include at least set screw port 204 in the hollow cylindrical frame, the screw port 204 configured to receive a screw via coupling of threading from the screw complementing threading from the screw port 204. The first open end 202 and the second end 205 may be configured to receive and cover portions of cables that have been spliced together. In some embodiments, the set screw port 204 may be threaded and be configured to receive a screw. In some embodiments, once an electrical cable is placed inside a portion of the cable splice assembly 200 one or more screws may be threaded into one or more set screw ports 204 to secure the electrical cable within the cable splice assembly 200. In some embodiments, as an alternative to screws, the cable splice assembly 200 may use threading and crimping to secure the connection between more than one power cables.

As shown in FIG. 2, a cable splice assembly 200 may have a hollow cylindrical frame having an inside diameter ranging from about 0.1 inches to about 10 inches. For example, the hollow cylindrical frame may have an inside diameter of about 0.1 inches, or about 1 inch, or about 2 inches, or about 4 inches, or about 6 inches, or about 8 inches, or about 10 inches, where about includes plus or minus 0.5 inches. The hollow cylindrical frame may have an outside diameter ranging from about 0.2 inches to about 11 inches. For example, the hollow cylindrical frame may have an outside diameter of about 0.2 inches, or about 1 inch, or about 2 inches, or about 4 inches, or about 6 inches, or about 8 inches, or about 10 inches, or about 11 inches, where about includes plus or minus 0.5 inches. The hollow cylindrical frame may have a length ranging from about 0.5 inches to about 10 inches. For example, the hollow cylindrical frame may have a length of about 0.5 inches, or about 1 inch, or about 2 inches, or about 4 inches, or about 6 inches, or about 8 inches, or about 10 inches, where about includes plus or minus 0.5 inches.

A cable splice assembly 200 may be made of conductive or non-conductive materials. For example, the cable splice assembly 200 may be made from a non-conductive material comprising a polymer comprising a polyethylene, a polystyrene, a polyvinyl chloride, a nylon, a polypropylene, a polyethylene terephthalate, a polycarbonate, and copolymers thereof. The cable splice assembly 200 may be made from a non-conductive material comprising a ceramic comprising porcelain, quartz, alumina, silica, boron nitride, aluminum nitride, silicon nitride, sialons, and combinations thereof. The cable splice assembly 200 may be made from a conductive material comprising silver, copper, gold, aluminum, nickel, brass, steel, platinum, lead, carbon steel, and alloys thereof.

A cable splice assembly 200, as shown in FIG. 2, may include from 1-20 set screw ports 204 in the hollow cylindrical frame. For example, the cable splice assembly 200 may have 1 set screw port, 2 set screw ports, 4 set screw ports, 6 set screw ports, 8 set screw ports, 10 set screw ports, 12 set screw ports, 14 set screw ports, 16 set screw ports, 18 set screw ports, or 20 set screw ports. Each set screw port 204 may have a diameter ranging from about 0.1 inch to about 1 inch. For example, each set screw port 204 may have a diameter of about 0.1 inch, or about 0.2 inches, or about 0.4 inches, or about 0.6 inches, or about 0.8 inches, or about 1 inch, where about includes plus or minus 0.1 inch. Additionally, besides having a cylindrical shape (i.e., circular cross-section), disclosed a cable splice assemblies 200 may have cross-sections including a square, a triangle, a circle, an oval, a polygon, a rectangle, a rhombus, and more.

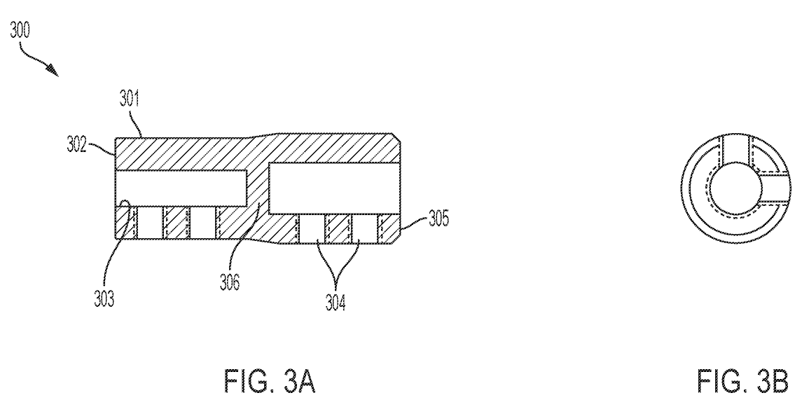

FIGS. 3A-3B are cross-sectional views of a cable splice assembly 300, in accordance with some embodiments. As shown in FIGS. 3A-3B, the cable splice assembly 300 may include an inside surface 303, an outside surface 301, a first open face 302, a second open face 305, and a plurality of set screw ports 304. In some embodiments, the set screw port 304 may be threaded and be configured to receive a screw. In some embodiments, once an electrical cable is placed inside a portion of the cable splice assembly 300 one or more screws may be threaded into one or more set screw ports 304 to secure the electrical cable within the cable splice assembly 300. The screws may be made of any metal (e.g., steel) or polymer (e.g., polyethylene). Additionally, as shown in FIG. 3A, the disclosed cable splice assembly 300 may include a divider 306 bisecting the hollow cylindrical frame. The divider 306 may be used to separate electrical cables from each other. For example, the cable splice assembly 300 may receive a first electrical cable into first open face 302 and a second electrical cable into second open face 305 so that each of the cables are separated by divider 306. In some embodiments, when the cable splice assembly 300 is made of a conductive material, the cables will be successfully spliced together so that a current may flow between the cables. The divider 306 may have a thickness ranging from about 0.1 inch to about 1 inch. For example, the divider 306 may have a thickness of about 0.1 inch, or about 0.2 inches, or about 0.4 inches, or about 0.6 inches, or about 0.8 inches, or about 1 inch, where about includes plus or minus 0.1 inch.

As shown in FIG. 3A, a cable splice assembly 300 may have various outside and inside diameters along the cylindrical frame. For example, the outside diameter of the hollow cylindrical frame at the first open end 302 may larger than the outside diameter of the hollow cylindrical frame at the second open end 305, or vice versa. In some embodiments, the inside diameter of the hollow cylindrical frame at the first open end 302 may larger than the inside diameter of the hollow cylindrical frame at the second open end 305, or vice versa. Additionally, besides having a cylindrical shape (i.e., circular cross-section), disclosed a cable splice assemblies 300 may have cross-sections including a square, a triangle, a circle, an oval, a polygon, a rectangle, a rhombus, and more.

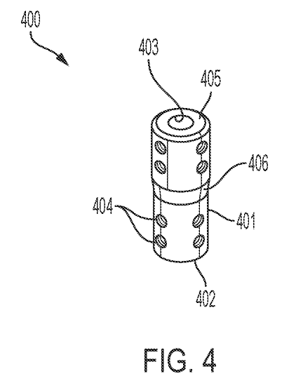

FIG. 4 is a side perspective of a cable splice assembly, in accordance with some embodiments. FIG. 4 shows a cable splice assembly 400 having an inside surface 403, an outside surface 401, a first open face 402, a second open face 405, a plurality of set screw ports 404, and a divider 405.

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Additionally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A cable splice sleeve assembly comprising:
(a) a removable core spirally wrapped to form a hollow cylinder having an outer surface, an inner surface, and an end piece, the inner surface configured to receive spliced cables; and
(b) a pre-expanded, elastomeric sleeve stretched to fit about the outside surface of the removable core,
wherein the removable core is configured so that pulling the end piece unravels the removable core, thereby removing the removable core from an interior surface of the elastomeric sleeve so that the elastomeric sleeve contracts onto the spliced cables.

2. The cable splice sleeve assembly according to claim 1, wherein the cable splice sleeve assembly is configured to provide insulation and protection for at least one of medium-voltage applications and high-voltage applications.

3. The cable splice sleeve assembly according to claim 1, wherein the removable core comprises one of:
a polymer comprising a polyethylene, a polystyrene, a polyvinyl chloride, a nylon, a polypropylene, a polyethylene terephthalate, a polycarbonate, and copolymers thereof; and
a metal comprising an aluminum, an iron, a steel, a copper, a zinc, a bronze, an alloy steel, a gold, a silver, a tin, and alloys thereof.

4. The cable splice sleeve assembly according to claim 1,
wherein the removable core has an inside diameter ranging from about 0.1 inches to about 10 inches,
wherein the removable core has an outside diameter ranging from about 0.2 inches to about 11 inches, and
wherein the removable core has a length ranging from about 0.5 inches to about 10 inches.

5. The cable splice sleeve assembly according to claim 1, wherein the flexible elastomeric sleeve comprises an elastomer comprising silicone rubber, natural rubber, styrene-butadiene, neoprene, chloroprene, polybutadiene, butyl rubber, ethylene propylene-diene monomer (EPDM) rubber, a nitrile, a polyurethane, a polyurethane, and co-polymers thereof.

6. The cable splice sleeve assembly according to claim 1, wherein the cable splice sleeve assembly is configured to provide insulation and protection for voltage applications ranging from about 1 kV to about 69 kV, or higher.

7. A method for installing a cable splice sleeve assembly, the method comprising:
(a) positioning the cable splice sleeve assembly so that an inner surface of a removable core of the cable splice sleeve assembly covers a junction at which electrical cables have been spliced together, wherein the cable splice sleeve assembly comprises:
(i) the removable core spirally wrapped to form a hollow cylinder having an outer surface, the inner surface, and an end piece; and
(ii) a pre-expanded, flexible elastomeric sleeve stretched to fit about the outside surface of the removable core;
(b) pulling the end piece to unravel the removable core, thereby removing the removable core from an interior surface of the elastomeric sleeve so that the elastomeric sleeve contracts onto the spliced cables.

8. The method according to claim 7, wherein the removable core comprises one of:
a polymer comprising a polyethylene, a polystyrene, a polyvinyl chloride, a nylon, a polypropylene, a polyethylene terephthalate, a polycarbonate, and copolymers thereof; and
a metal comprising an aluminum, an iron, a steel, a copper, a zinc, a bronze, an alloy steel, a gold, a silver, a tin, and alloys thereof.

9. The method according to claim 7,
wherein the removable core has an inside diameter ranging from about 0.1 inches to about 10 inches,
wherein the removable core has an outside diameter ranging from about 0.2 inches to about 11 inches, and
wherein the removable core has a length ranging from about 0.5 inches to about 10 inches.

10. The method according to claim 7,
wherein the removable core has an inside diameter ranging from about 0.1 inches to about 10 inches, and
wherein the removable core has an outside diameter ranging from about 0.2 inches to about 11 inches.

11. A cable splice assembly comprising:
a hollow cylindrical frame comprising a first open end connected to a second open end by an elongate body;
an outer surface and an inner surface; and
at least one set screw port in the hollow cylindrical frame.

12. The cable splice assembly according to claim 11, wherein the hollow cylindrical frame has an inside diameter ranging from about 0.1 inches to about 10 inches.

13. The cable splice assembly according to claim 11, wherein the hollow cylindrical frame has an outside diameter ranging from about 0.2 inches to about 11 inches.

14. The cable splice assembly according to claim 11, wherein the hollow cylindrical frame has a length ranging from about 0.5 inches to about 10 inches.

15. The cable splice assembly according to claim 11, wherein one of:
the cable splice assembly is made from a non-conductive material comprising a polymer comprising a polyethylene, a polystyrene, a polyvinyl chloride, a nylon, a polypropylene, a polyethylene terephthalate, a polycarbonate, and copolymers thereof,
the cable splice assembly is made from a non-conductive material comprising a ceramic comprising porcelain, quartz, alumina, silica, boron nitride, aluminum nitride, silicon nitride, sialons, and combinations thereof, and
the cable splice assembly is made from a conductive material comprising silver, copper, gold, aluminum, nickel, brass, steel, platinum, lead, carbon steel, and alloys thereof.

16. The cable splice assembly according to claim 11, further comprising at least one screw configured to fit inside the least one set screw port.

17. The cable splice assembly according to claim 11, wherein the cable splice assembly has from 1 to 20 set screw ports in the hollow cylindrical frame.

18. The cable splice assembly according to claim 11, wherein the at least one set screw port through the hollow cylindrical frame has a diameter ranging from about 0.1 inch to about 1 inch.

19. The cable splice assembly according to claim 11, wherein the outside diameter of the hollow cylindrical frame at the first open end is larger than the outside diameter of the hollow cylindrical frame at the second open end.

20. The cable splice assembly according to claim 11, further comprising a divider bisecting the hollow cylindrical frame, the divider having a thickness ranging from about 0.01 inch to about 1 inch.
